(19) United States
(12) Patent Application Publication
(10) Pub. No.: US 2010/0053080 A1
(43) Pub. Date: Mar. 4, 2010

(54) Method For Setting Up Location Information On Display Screens And A Recognition Structure Thereof

(76) Inventor: Yuh-Pyng SHIEH, Fengyuan City (TW)

Correspondence Address: FRENKEL & ASSOCIATES, 3975 UNIVERSITY DR., STE. 330, FAIRFAX, VA, 22030, US

(21) Appl. No.: 12/203,220

(22) Filed: Sep. 3, 2008

(51) Int. Cl. G06F 3/033

(52) U.S. Cl. 345/157

(57) ABSTRACT

A method for setting up location information on display screens and a recognition structure thereof includes an encoding unit and an image generation unit to output respectively at least one location information and a plurality of image information in a unit of time, and a synthesizing unit to integrate the location information and the image information to become synthesized information transmitted to a display unit to be output. The invention further has an image capturing unit to capture local information of the synthesized information from any location of the display unit. The local information is sent to a recognition unit to be recognized. The recognition unit outputs a recognition signal to the image generation unit which in turns outputs the image information of a location on the display unit pointed by the image capturing unit. This invention can accomplish effects same as the touch screen.

### FIELD OF THE INVENTION

The present invention relates to a method for setting up location information on display screens and a recognition structure thereof and particularly to method for setting up location information on display screens of electronic devices and a recognition structure to recognize the location information.

### BACKGROUND OF THE INVENTION

Advance of technology has spawned many operation techniques for electronic devices (such as computers, mobile phones, PDAs and the like). Aside from conventional operation means such as mouse, button keys and the like, touch screen also has been developed in recent years that can be used to control movement of a cursor on the screen through a stylus or user's finger to allow users to make movement and selection and drive the electronic devices to perform processes. In addition to the touch control operation, many other types of operation techniques also have been developed. For instance, China patent Nos. CN1337611, CN1731385, CN1754200, and Taiwan patent Nos. M324266 and 200737116 disclose techniques that control movement of a cursor by picture taking through a video camera.

CN1337611 adopts a movable lighting device on a table top to generate movement and a video camera linking to a computer to capture the moving track of a light spot of the lighting device. The captured track is processed and converted to XY coordinate data, and then the cursor can be moved according to the moving track of the lighting device.

CN1731385 provides a method to do position pointing through a designated picture to play shooting games with light guns on any type of display screens without constrained by screen types. The game machine is connected to a preset position pointing device and a display screen. When the game machine is executing game software, the designated picture is sent to the display screen for displaying at a constant time interval, and the designated picture also is sent to the position pointing device for storage. When users control the game through the position pointing device, the pictures taken by the position pointing device are compared with the stored designated picture to do recognition. Hence the coordinates of the aiming spot of the position pointing device on the display screen can be calculated accurately and quickly.

CN1754200 discloses an optical mark positioning device through picture taking. A photo optical mark device is provided that has an image synthesizing circuit to synthesize a selected mark or optical mark to be displayed on a screen; then the picture of the display area on the screen that contains the selected mark or optical mark is taken through a video camera; the image signal is sent to a control circuit to generate coordinate data of the selected mark or optical mark and an aiming spot or center point of the captured image; the data are sent to the image synthesizing circuit which synthesizes the selected mark or optical mark in the image signal based on the coordinate data; the synthesized image signal is sent to the display area of the screen for displaying, and the coordinate values of the selected mark or optical mark are sent to an information system. Thus, any type of screens can be controlled through the optical mark positioning device without limitation. It can replace the traditional method that controls optical marks through a mouse.

M324266 provides a small camera built-in a portable device to capture image information of a user's fingers and transmit the image information to an image processing program in the portable device to perform analysis to recognize the location of a gap between two finger tips of the user. The information is converted to a cursor location on the screen of the portable device. By controlling the cursor location on the screen or selecting a functional menu on the screen, the function of a stylus or button key can be replaced. 200737116 discloses a system to control the cursor of a computer mouse through a laser light spot. It adopts a technique by pointing the laser light spot to an image of a displaying picture to process digital images and to detect the location of the laser light spot in the captured image, then instantly controls the computer mouse cursor. Users can control movement of the cursor through the pointing direction of the laser light spot.

All the aforesaid techniques mainly aim to control target (cursor) location through the moving track of a light spot or fingers captured by a video camera. However, the video camera can take pictures only within a specific photo range. Users are not always aware of the photo range and are prone to move the light spot or fingers beyond the photo range during operation. Then loss control of the target location happens. Moreover, the aforesaid techniques cannot be directly adopted on display devices. They do not provide a direct operation approach, thus cannot fully meet user's requirements.

### SUMMARY OF THE INVENTION

The primary object of the present invention is to solve the aforesaid disadvantages by providing a technique that allows a video camera in direct contact with a screen to take pictures to control the location of a screen target (cursor) to facilitate user operation.

To achieve the foregoing object the invention provides a method for setting up location information on a display screen. The method includes:

providing a plurality of image information;

providing at least one location information of the display screen; and

integrating the location information and the image information through an integration measure to become a synthesized information.

The invention also provides a location recognition structure for a display screen. It includes:

an encoding unit to output at least one location information in a unit of time;

an image generation unit to continuously output a plurality of image information in the unit of time;

a synthesizing unit to get the image information and the location information and output a synthesized information;

a display unit linking to the synthesizing unit to gain and output the synthesized information;

an image capturing unit to capture local information at any location of the display unit; and

a recognition unit linking to the image capturing unit to gain the local information and output a recognition information to the image generation unit to output image information of the location pointed by the image capturing unit on the display unit.

Compared with the conventional techniques, the method and structure of the invention provide significant benefits to users such as simpler operation.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of the invention.

FIG. 2 is schematic view-1 of the integration measure of the invention.

FIG. 3 is schematic view-2 of the integration measure of the invention.

FIG. 4 is schematic view-3 of the integration measure of the invention.

FIG. 5 is schematic view-4 of the integration measure of the invention.

FIGS. 6A and 6B are schematic views of location information according to the invention.

FIG. 7 is another structural block diagram of the invention.

FIG. 8 is a schematic view of a preferred embodiment of the invention.

### DETAILED DESCRIPTION OF THE PREFERRED EMBODIMENTS

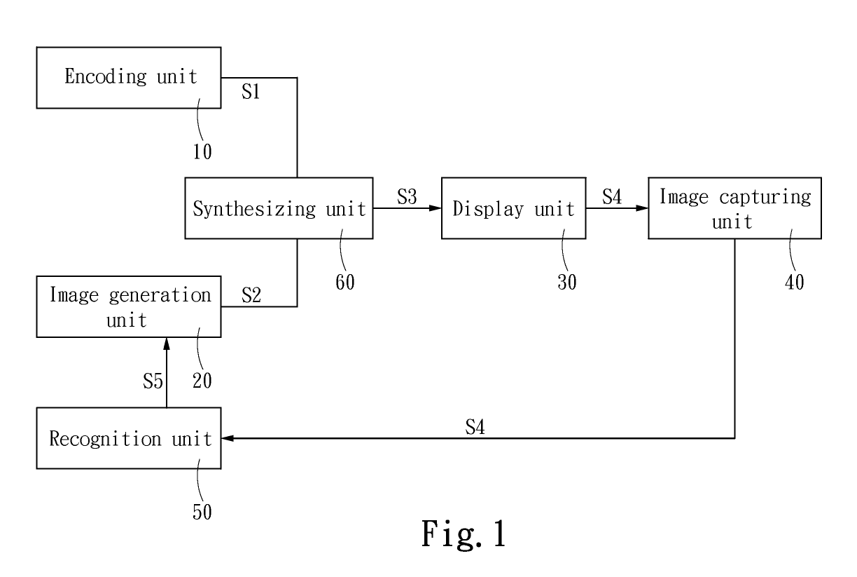

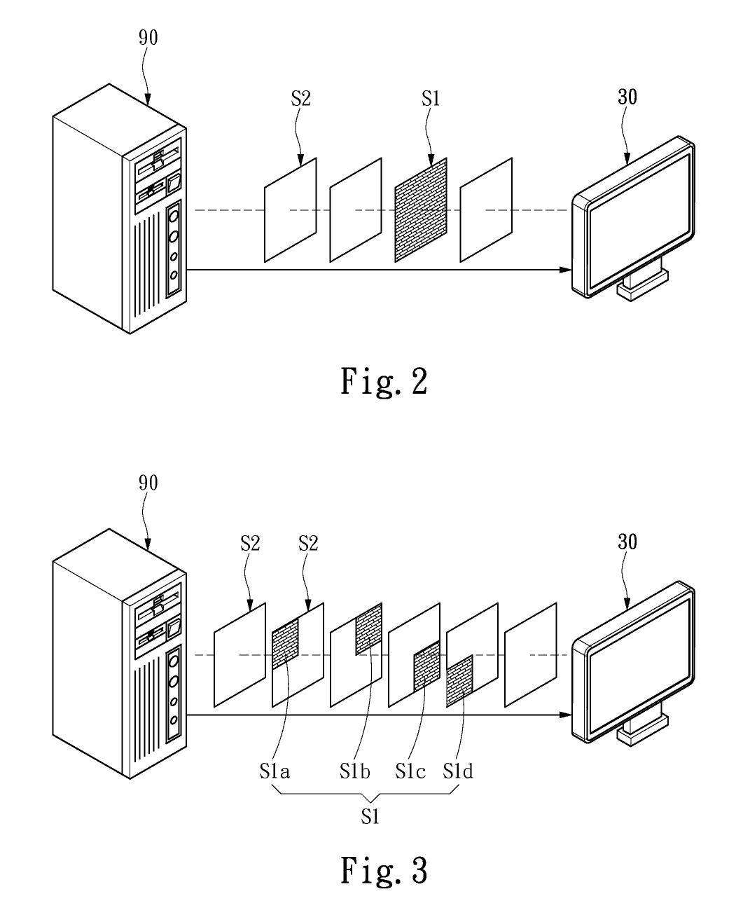

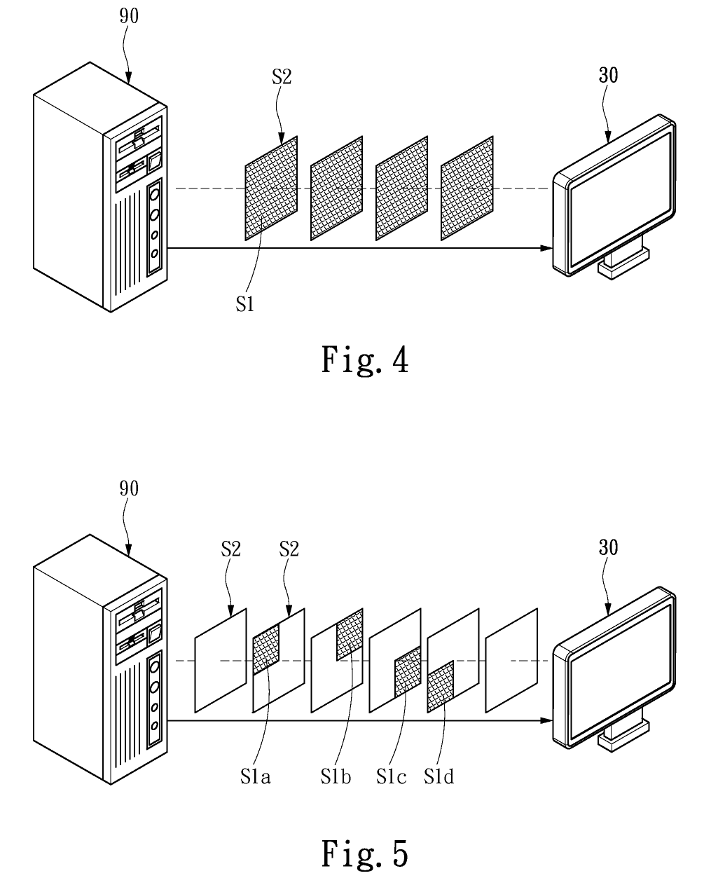

Please referring to FIG. 1, the present invention mainly includes an encoding unit 10 (such as an encoder), an image generation unit 20, a synthesizing unit 60 connecting to the encoding unit 10 and the image generation unit 20, a display unit 30 linking to the synthesizing unit 60, an image capturing unit 40 and a recognition unit 50 (such as a decoder). The encoding unit 10 outputs at least one location information S1 (such as XY coordinate) of the display unit 30 within a unit of time. The image generation unit 20 continuously outputs in the unit of time a plurality of image information S2. The synthesizing unit 60 integrates through an integration measure the location information S1 and the image information S2 to become a synthesized information S3 output through the display unit 30. The integration measure may adopt Time Division Multiplexing (TDM) as shown in FIG. 2, with the location information S1 interposed between the image information S2 or replaced one of the image information S2. It can also adopt Space Division Multiplexing (SDM) as shown in FIG. 3 in which the location information S1 includes a plurality of segment information S1a, S1b, S1c and S1d contained in the image information S2. The encoding unit 10 can output the complete location information S1 in the unit of time. Through visual persistence characteristics of human eye the location information S1 and the image information S2 are integrated to become the synthesized information S3 output through the display unit 30. When people use this technique in normal conditions they can sense no interference caused by the location information S1. Moreover, referring to FIG. 4, the location information S1 can be positioned onto the image information S2 as watermark information. Referring to FIG. 5, the segment information S1a, S1b, S1c and S1d may also be located on the image information S2 as watermark information. In an embodiment of the invention, the image generation unit 20 is a display card (such as VGA card) to output the image information S2, the synthesizing unit 60 is a synthesizer located between the encoding unit 10, image generation unit 20 and the display unit 30, or located on the same display card with the encoding unit 10 and image generation unit 20 to output the synthesized information S3 to the display unit 30, or even located on a display screen with the encoding unit 10 and the display unit 30 to receive the location information S1 and image information S2 and output the synthesized information S3.

The integration measure, aside from being implemented through the hardware structure set forth above, the encoding unit 10, image generation unit 20 and synthesizing unit 60 may also be installed on an operating system or a software resided in the operating system to output the location information S1 and image information S2, and integrate them to become the synthesized information S3 transmitted to the display unit 30. The image capturing unit 40 is a video camera with a refresh rate of 16 or more, and can capture local information S4 of the synthesized information S3 at any location of the display unit 30 and transmit the local information S4 to the recognition unit 50. The recognition unit 50 performs recognition and outputs a recognition signal S5 to the image generation unit 20. Then the image generation unit 20 outputs the image information S2 of the pointing location of the image capturing unit 40 on the display unit 30.

As the minimum display element of the display unit 30 is a pixel, the minimum image capturing element of the image capturing unit 40 also is a pixel. After having taken a picture, the image capturing unit 40 gets information only from the color of the pixel or the relative position of other specific recognized pixels, such as the relative position of the center point of the captured image related to fixed points described later. Although the presentation of a color-rich pixel can carry a great amount of information, color errors often occur during picture taking process. In order to successfully recognize the information carried by the pixel color, only the information carried by some selected color zones are set. Take a full color video display as an example, one pixel can have 2²⁴ color variations. Stored with three bytes, the presentation can carry 24 bits of information. But errors in image taking make the amount of information that can be carried smaller. Hence the information amount carried by one pixel could be inadequate to show the absolute location of the pixel on the display unit 30. Therefore the invention gathers the pixels in the neighborhood to present the absolute location information through colors for a fixed spot of the selected zone on the display unit 30.

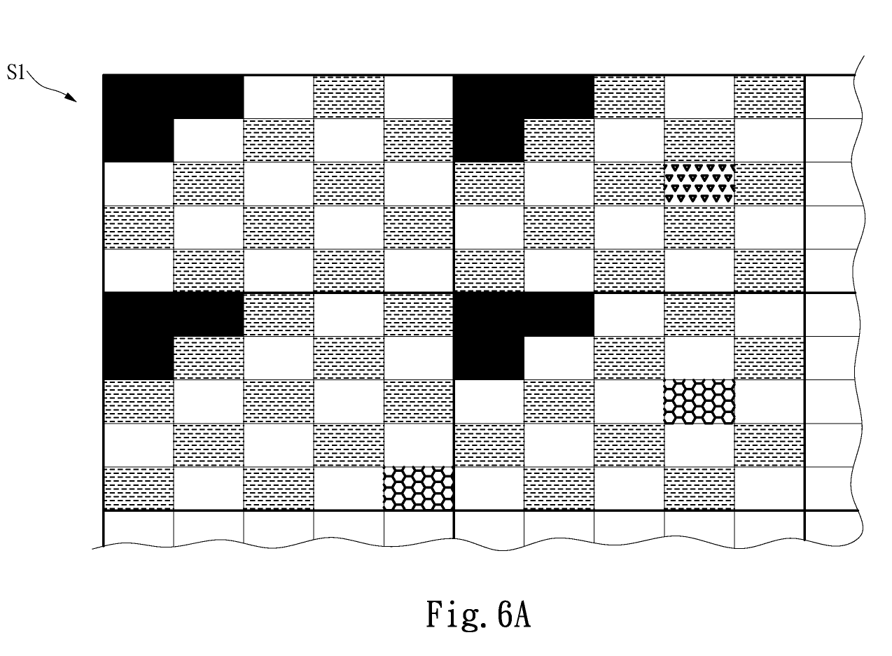

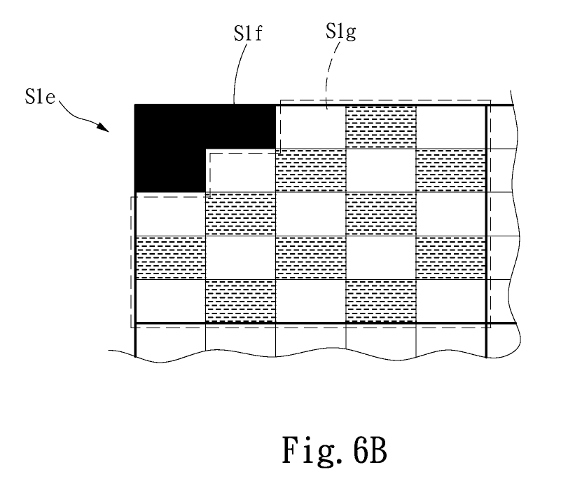

Refer to FIGS. 6A and 6B for the encoding method and picture taking process of the invention. After image taking, the image capturing unit 40 gets information only through the pixel color and the relative location with other fixed points (described later). Hence the invention presents an encrypted value by color on the location information S1 to facilitate image taking of the image capturing unit 40. As the information amount presentable by one pixel could be not adequate to indicate the absolute location of the pixel, the invention first divides the location information S1 into a plurality of fixed point information S1e. When the image capturing unit 40 proceeds image taking, the image capturing unit 40 is prone to swivel and results in swiveling of the captured information. If the abutting pixels also have the same color, borders of the pixels are difficult to recognize. Hence each fixed point information S1e contains a direction identification (ID) information S1f embedded with the encrypted value of the absolute location and a plurality of location description information S1g embedded with a fixed point location encrypted value to describe the absolute location of a specific point (called fixed point) of the fixed point information S1e. As shown in the drawings, each location description information S1g occupies one pixel, and other location description information S1g at abutting locations up and down, and left and right thereof is being defined with different colors to facilitate recognition of the borders thereof. As the location of each fixed point information S1e is different, the abutting location description information S1g of different fixed point information S1e are indicated by different colors to show the fixed point location encrypted value. The direction ID information S1f occupies three or more pixels to confirm the swiveling angle of image taking. Then the fixed point information S1e with the number of pixels that can carry sufficient information amount to describe the fixed point absolute location is formed. For instance, given one pixel to carry one bit of information, 5×5 pixels consume the pixels used by the direction ID information S1f of three pixels. X and Y axes have respectively usable information amount of 12 bits to define any point on a screen with resolution of 4096*4096. Thus, after the image capturing unit 40 has got the local information S4 and sent to the recognition unit 50, the recognition unit 50 first analyzes and gets the image swiveling angle through the direction ID information S1f; then the absolute location of the fixed point pointed by the fixed point information S1e is confirmed through the fixed point location encrypted value represented by the location description information S1g. And based on the relative location of the pointing location (usually the center point of the taken image) of the image capturing unit 40 and the absolute location of the fixed points recognized by the fixed point information S1e, the absolute location pointed by the image capturing unit 40 can be calculated through the local information S4.

In the event that the information amount carried by one pixel is sufficient to indicate the absolute location of the pixel on the display unit 30, such as one pixel carrying 24 bits of information has usable information of 12 bits on X and Y axes to define any spot on the screen with resolution of 4096*4096. Then the scope covered by the fixed point information S1e can be merely one pixel, and no direction ID information S1f is required to recognize directions. The location description information S1g is same as the fixed point information S1e.

The location description information S1g, aside from recording the absolute location of the fixed point pointed by the fixed point information S1e, also can be altered to record the zone location of the pointed fixed point. Referring to FIG. 3, the segment information S1a-S1d can be divided into a plurality of fixed point information S1e according to the encoding method previously discussed. Each of the segment information S1a-S1d represents a selected zone of the location information S1, and a same segment information S1a-S1d has a plurality of fixed point information S1e coded with a same zone location encrypted value. The fixed point information S1e of different segments information S1a-S1d has a different encrypted value. Hence when the image capturing unit 40 points to any location of the selected segment information value S1a-S1d, the same zone location encrypted value can be obtained. Meanwhile the information carried by the fixed point information S1e is not the absolute location of the pointed fixed point, but the zone where the pointed fixed point is located. This method is adaptable to children education software in which the information to be identified often are some selected zones pointed by the image capturing unit 40. The segment information S1a-S1d previously discussed aim to indicate different zones, and may be different from the divided segment information S1a-S1d used in the SDM.

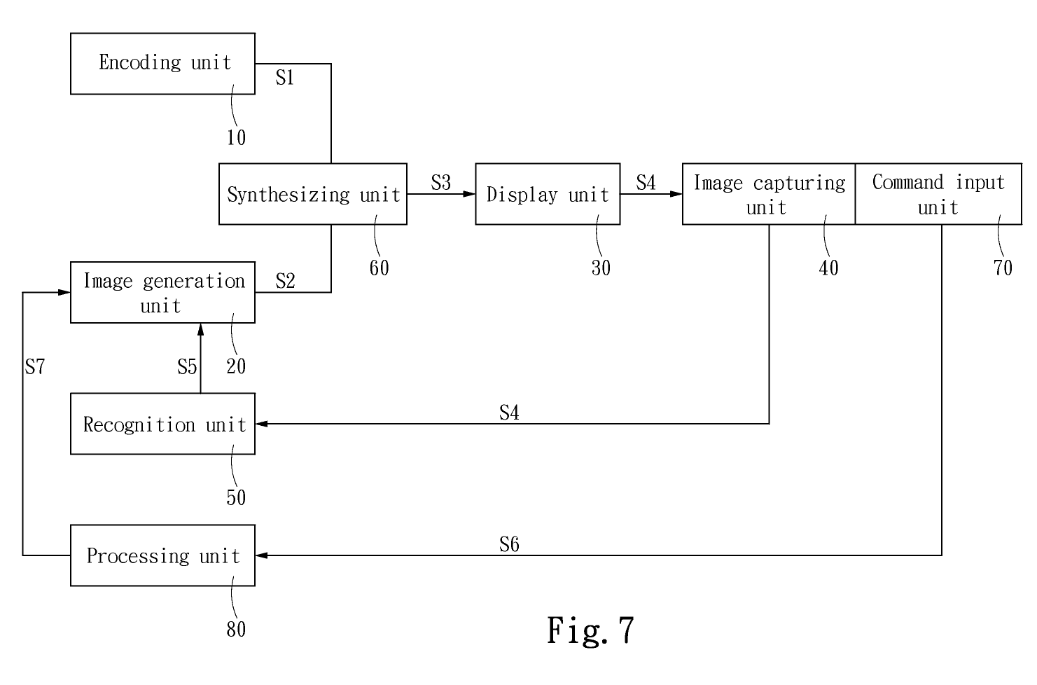

Referring to FIG. 7, the image capturing unit 40 is connected to a command input unit 70. While the image capturing unit 40 captures the local information S4, the command input unit 70 also outputs a command signal S6 (such as start, stop, pressure information and or like) to a processing unit 80 which performs processing and outputs a processing signal S7 to the image generation unit 20. The image processing unit 20 in turn outputs the processing result through the image information S2. The command input unit 70 may be a pushbutton, a switch and feedback commands generated by the image capturing unit 40 upon detecting pressure on the display unit 30.

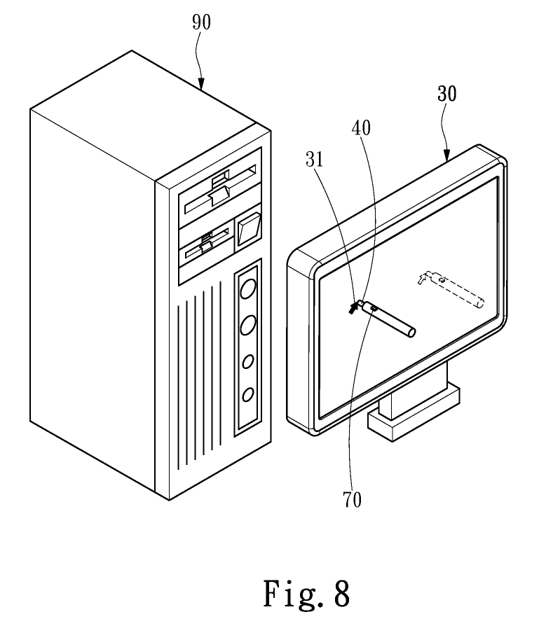

Refer to FIG. 8 for an embodiment of the invention. The display unit 30 is used on an electronic device 90 which can transmit a plurality of image information S2 to the display unit 30. The electronic device 90 is not limited to a personal computer as shown in the drawing, but may also be a notebook computer, mobile phone, PDA, digital camera, digital photo frame, and the like. When the image capturing unit 40 is moved from a first location to a second location, through changes of the local information S4, the cursor 31 on the display unit 30 also is moved with the image capturing unit 40 to the second location.

As a conclusion, the invention, by taking images through the image capturing unit 40 at a short distance from the display unit 30, can simulate the operation of a touch screen. Through the image capturing unit 40, the location information S1 output from the display unit 30 can be obtained, and the location information S1 is analyzed through the recognition unit 50 so that the cursor 31 on the display unit 30 displays the pointing location of the image capturing unit 40. It not only provides a direct operation method for users, also can accomplish effects same as the touch screen but at a lower production cost. Moreover, the ordinary display screen now being used can be upgraded to become a touch screen through the invention. Compared with the conventional techniques, the invention provides a great benefit of simpler user operation.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for setting up location information on a display screen, comprising:
providing a plurality of image information;
providing at least one location information of the display screen; and
integrating the location information and the image information through an integration measure to become a synthesized information.

2. The method of claim 1, wherein the integration measure interposes the location information between the image information.

3. The method of claim 1, wherein the integration measure overlays the location information on the image information to form watermark information.

4. The method of claim 1, wherein the integration measure replaces at least one image information with the location information.

5. The method of claim 1, wherein the location information includes a plurality of segment information.

6. The method of claim 1, wherein the location information includes a plurality of fixed point information, each fixed point information including at least one set of location description information to describe a fixed point location of the fixed point information.

7. The method of claim 6, wherein the location description information includes a fixed point location encrypted value to describe an absolute location of the fixed point pointed by the fixed point information.

8. The method of claim 6, wherein the location description information includes a fixed point location encrypted value to describe a zone location of the fixed point location.

9. A location recognition structure for a display screen comprising:
an encoding unit to output at least one location information in an unit of time;
an image generation unit to continuously output a plurality of image information in the unit of time;
a synthesizing unit linking to the encoding unit and the image generation unit to get the location information and the image information and output a synthesized information;
a display unit linking to the synthesizing unit to get and output the synthesized information;
an image capturing unit to capture the local information at any location on the display unit; and
a recognition unit linking to the image capturing unit to get the local information and output a recognition signal to the image generation unit which in turn outputs the image information of a location on the display unit pointed by the image capturing unit.

10. The location recognition structure of claim 9, wherein the location information includes a plurality of segment information.

11. The location recognition structure of claim 9, wherein the location information includes a plurality of fixed point information, each fixed point information including at least one set of location description information to describe a fixed point location of the fixed point information.

12. The location recognition structure of claim 11, wherein the location description information includes a fixed point location encrypted value to describe an absolute location of the fixed point location of the fixed point information.

13. The location recognition structure of claim 11, wherein the location description information includes a fixed point location encrypted value to describe a zone location of the fixed point location of the fixed point information.

14. The location recognition structure of claim 9, wherein the image generation unit and the synthesizing unit are located on a display card to output the synthesized information to the display unit.

15. The location recognition structure of claim 9, wherein the synthesizing unit is a synthesizer located between the encoding unit, the image generation unit and the display unit.

16. The location recognition structure of claim 9, wherein the synthesizing unit and the display unit are located on the display screen to receive the location information and the image information and output the synthesized information.

17. The location recognition structure of claim 9, wherein the synthesizing unit is located in an operating system or software resided in the operating system to output the location information and the image information and integrate thereof to form the synthesized information.

18. The location recognition structure of claim 9, wherein the display screen corresponds to an electronic device which is selected from the group consisting of a personal computer, a notebook computer, a mobile phone, a PDA, a digital camera and a digital photo frame.

19. The location recognition structure of claim 9, wherein the image capturing unit is linked to a command input unit to generate command signals.

20. The location recognition structure of claim 19, wherein the command signals are selected from the group consisting of start signals, stop signals and pressure signals.
